(19) United States
(12) Patent Application Publication
(10) Pub. No.: US 2004/0045162 A1
(43) Pub. Date: Mar. 11, 2004

(54) Method for carrying out nondestructive testing of alloys, which contain carbides or which are sulfided near the surface, and for producing a gas turbine blade

(76) Inventors: Thomas Beck, Zepernick (DE); Ralph Reiche, Berlin (DE); Rolf Wilkenhoner, Berlin (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/661,190

(22) Filed: Sep. 12, 2003

(30) Foreign Application Priority Data
Mar. 16, 2001 (EP) 01106705.5
Jun. 15, 2001 (DE) 10128961.8

(51) Int. Cl. B21K 3/04; G01N 17/00; G01N 27/90; G01B 7/06; B23P 15/02

(52) U.S. Cl. 29/889.71; 324/229; 29/407.05

(57) ABSTRACT

The invention relates to a method for carrying out nondestructive testing of a gas turbine blade during which corrosion areas, which are located near the surface and which consist of oxidized carbides or of base material that is sulfidized near the surface, are determined by means of an eddy current measurement. As a result, the blades can be ground or sorted, in particular, before subjecting the gas turbine to a complicated cleaning and coating process.

### DESCRIPTION

Method for non-destructive testing of carbide-containing or near-surface sulfidized alloys and for the manufacture of a gas turbine blade.

The invention relates to a method for non-destructive testing of a nickel- or cobalt-based alloy. The invention also relates to a method for the non-destructive testing of a gas turbine blade of a nickel- or cobalt-based alloy.

The invention also refers to a method for the non-destructive testing of alloys containing carbides. The invention also relates to a method for the non-destructive testing of a gas turbine blade made of an alloy containing carbides. The invention further relates to a method for the manufacture of a gas turbine blade with the body of the gas turbine blade being cast, the surface of the body being cleaned and activated for the application of an anti-corrosive coating, and the anti-corrosive coating then being applied.

In the book by H. Blumenauer “Werkstoffprüfung” [Materials testing], 5^{th} edition, V E B Deutscher Verlag für Grundstoffindustrie, Leipzig 1989, non-destructive testing of materials using the eddy-current method is described. The basis of this is that the electromagnetic alternating field of a coil through which an alternating current flows is changed if a metallic probe is brought into its active area. The primary field of the coil induces in the specimen to be tested an alternating voltage that itself creates an alternating current that in turn generates a magnetic alternating field. This secondary alternating field characteristically acts against the primary field and thus changes its parameters. This change can be measured. To do this, for example on coils with a primary and secondary winding, the secondary voltage is measured (transformation principle), or for

example on coils with only one winding, their impedance is determined (parametric principle). In accordance with the laws that apply in an alternating current, with the parametric arrangement the induction in the coil and in the specimen creates an inductive resistance in addition to the ohmic resistance and with the transformation arrangement creates an imaginary measured voltage in addition to the real measured voltage. Both components are shown in complex form in the impedance resistance level or complex voltage level. In both of these examples, the non-destructive materials testing utilizes the fact that changes in the primary field depend on the physical and geometric properties of the specimen and the properties of the device. The main properties of the device are the frequency, current, voltage and the number of coil windings. The main properties of the specimen are electrical conductivity, permeability, the shape of the specimen and the material inhomogenieties in the area of the eddy-currents. Later devices for inductive testing permit measurements at several excitation frequencies. Also, for example, the frequency can be automatically changed during a measurement or manually adjusted by the user during two measurements. The frequency has an essential influence on the depth of penetration of the eddy-current. The following applies as an approximation.

$$δ = \frac{503}{\sqrt{f \cdot σ \cdot {μ}_{r}}}$$

δ [mm] depth of penetration

f [Hz] frequency

σ [MS/m=m/Ωmm²)] specific conductivity

μᵣ relative permeability

The standard depth of penetration reduces with increasing frequency.

The article “Non-Destructive Testing of Corrosion Effect on High Temperature Protective Coatings” by G. Dibelius, H. J. Krischel and U. Reimann, V G B Kraftwerkstechnik 70 (1990), No. 9 describes a non-destructive test of corrosion processes in protective coatings of gas turbine blades. A method of measurement used for nickel-based protective coatings is to measure the magnetic permeability of ferromagnetism in the protective coating that changes during the corrosion process. The possibility of eddy-current measurement for platinum-aluminum protective coating systems is discussed. The thickness of the protective coating can be determined on the basis of the measured signal levels.

The article “How to cast Cobalt-Based Superalloys” by M. J. Woulds in: Precision Metal, April 1969, p. 46, and in the article by M. J. Woulds and T. R. Cass, “Recent Developments in MAR-M Alloy 509”, Cobalt, No. 42, pages 3 to 13, describe how, when casting components such as gas turbine blades, a reaction of the solidifying, or already solidified, component surface with the material of the casting shell occurs. This can, for example, cause oxidation of carbides in the casting. This process is referred to in the following as inner carbide oxidation (ICO). The occurrence of ICO leads to a breakdown of the carbide that strengthens the grain boundaries of an alloy. Particularly in the near-surface area of a gas turbine blade this can lead to substantial weakening of the material. The alloys are normally cast using vacuum casting. The oxygen required for oxidation comes from the material of the casting shell, e.g. silicon dioxide, zircon dioxide or aluminum oxide. This produces oxide phases at the grain boundaries. The original carbides are, for example, transformed to oxides rich in zircon, titanium or tantalum. The depth of the area containing the oxidated carbides depends on parameters such as carbon content in the alloy, the composition of the material of the casting shell and the casting alloy, or also the cooling rate. An oxide-containing coating of this kind can typically be approximately 100 to 300 μm thick. For quality control it is desirable to be able to verify the oxide areas of oxidated carbides that impair the mechanical properties. Up to now it has not been possible to do this non-destructively.

Alloys based on nickel and cobalt have a tendency, under certain environmental conditions, to develop a form of corrosion known as high-temperature corrosion. From the point of view of material, high-temperature corrosion is a complex sulfidation of the parent material running along the grain boundaries. As high-temperature corrosion progresses, load-bearing cross-sections of components are weakened. Knowledge of the depth of a high-temperature corrosion attack is important to be able to estimate the operating safety and residual service life of a component, and therefore to be able to decide whether reworking (e.g. refurbishment of gas turbine blades) is possible.

The object of the invention is to provide a method of non-destructive testing of alloys containing carbides, whereby the near-surface oxide areas of oxidated carbides can be determined. A further object of the invention is the provision of a method for non-destructive testing of a gas turbine blade of an alloy containing carbides. It is, furthermore, an object of the invention to provide a method for the manufacture of a gas turbine blade with an anti-corrosive coating being applied to the body of the gas turbine blade casting, with the quality and service life of the anti-corrosive coating being particularly high.

The object of the invention is also to provide a method for non-destructive testing of nickel- or cobalt-based alloy, with it being possible to determine the near-surface sulfidized corrosion areas. A further object of the invention is to provide a method for non-destructive testing of a gas turbine blade made of nickel- or cobalt-based alloy.

The object of a procedure for testing alloys containing carbides is achieved in accordance with the invention by providing a method for non-destructive testing of alloys containing carbides, with the near-surface oxide areas of oxidated carbides being determined by means of eddy-current measurement.

Surprisingly, it has been shown that the oxide areas of oxidated carbides (ICO, see above) or the corrosion areas of sulfidized parent material can be verified with sufficient accuracy by means of eddy-current measurement. As already stated, eddy-current measurement of this kind is based particularly on the fact that the electrical conductivity within the ICO areas is different from that of the parent material. Tests were also able to show that the sensitivity of the method is even sufficient to determine the depth of the ICO coatings present. As already described, eddy-current measurements at different excitation frequencies are necessary for this purpose. At suitably low frequencies, the eddy-current propagation in the ICO coating is negligible and the measurement is thus determined only by the properties of the parent material. In a transition area, the change to the primary field depends on the eddy-currents both in the undisturbed parent material and in the ICO coating. Above a certain frequency level, the eddy-current field propagates only in the ICO coating. Therefore, a defined transition occurs in the measured variable (e.g. conductivity or permeability) as a function of the excitation frequency. Correlation of the frequency at which the influence of the ICO coating predominates with the depth of penetration of the eddy-current field enables the thickness of the ICO coating to be determined.

In accordance with the invention, the object of a method for non-destructive testing of a gas turbine blade is achieved by providing a method for non-destructive testing of a gas turbine blade of a carbide-containing alloy, with the near-surface oxide areas of oxidated carbides being determined by means of eddy-current measurement.

The object of the invention with regard to the aforementioned method is achieved by the methods in accordance with claims 1, 2, 4, and 7.

The object of providing a method of non-destructive of testing of a gas turbine blade is achieved by the invention by means of a method in accordance with claim 8.

Particularly with a gas turbine blade, a particularly high quality of fault-free microstructure of the parent material is necessary because of the high thermal and mechanical stresses. A quality test of the ICO coating or corroded areas is thus of great value particularly in this area.

A nickel- or cobalt-based superalloy is preferred. Superalloys of this kind are best known in gas turbine engineering and are characterized particularly by high-temperature creep resistance. However, such superalloys have a tendency during casting to react with the oxygen of the mold and thus deform the mentioned ICO areas.

The object of a method of manufacture is achieved by the invention by a method for the manufacture of a gas turbine blade, with a body of the gas turbine blade being cast, the surface of the main body being cleaned and activated for the application of an anti-corrosive coating and the anti-corrosive coating then being applied, with the surface being tested for the presence of oxide areas of oxidated carbides, after casting and before cleaning and activating, by means of eddy-current measurement.

For gas turbine blades, anti-corrosive coatings are frequently used that are applied to the main body. The main body in this case is formed from a nickel- or cobalt-based superalloy. It is further preferred that the protective coating consists of a MCrAlY type of alloy, with M being selected from the (iron, cobalt, nickel) group, Cr chrome, Al Aluminum and yttrium being selected from the (yttrium, lanthanum, rare earths) group. A protective coating of this kind requires a pretreatment of the surface of the main body in order to guarantee a durable bond between the main body and protective coating. A suitable cleaning process, that at the same time activates the surface for a good bond with the protective coating, is a sputter process whereby ions are accelerated on the surface of the main body and the surface is thus cleaned and activated by their kinetic energy. Tests have now shown that ICO areas in the surface layer prevent suitable cleaning and activation of the surface of the main body. The ICO areas cannot be removed by the sputter process. They are completely exposed because metal or impurities by which they have been partially covered is removed but not the oxides themselves. This leads to a substantial impairment of the bond between the protective coating and main body of the blade.

For gas turbine blades, eddy-current measurement is used in order to be able to determine before the expensive cleaning and coating process whether ICO areas are present on the surface of the main body. This means that it is now possible for the first time to cost-effectively clean blades with ICO areas in advance using a grinding process, or to reject them in advance. Successfully cleaned blades or those blades with no ICO areas to start with are thus provided with a protective coating, preferably using plasma spraying.

The preferred composition of the superalloy main body is preferably as follows (details given in percentages by weight).

24% chrome, 10% nickel, 7% tungsten, 3.5% tantalum, 0.2% titanium, 0.5% zircon, 0.6% carbon and the remainder cobalt. This alloy goes under the commercial name MAR-M 509.

Examples of the invention are explained in more detail by means of drawings. The drawings are listed below and are sometimes schematic and not to scale.

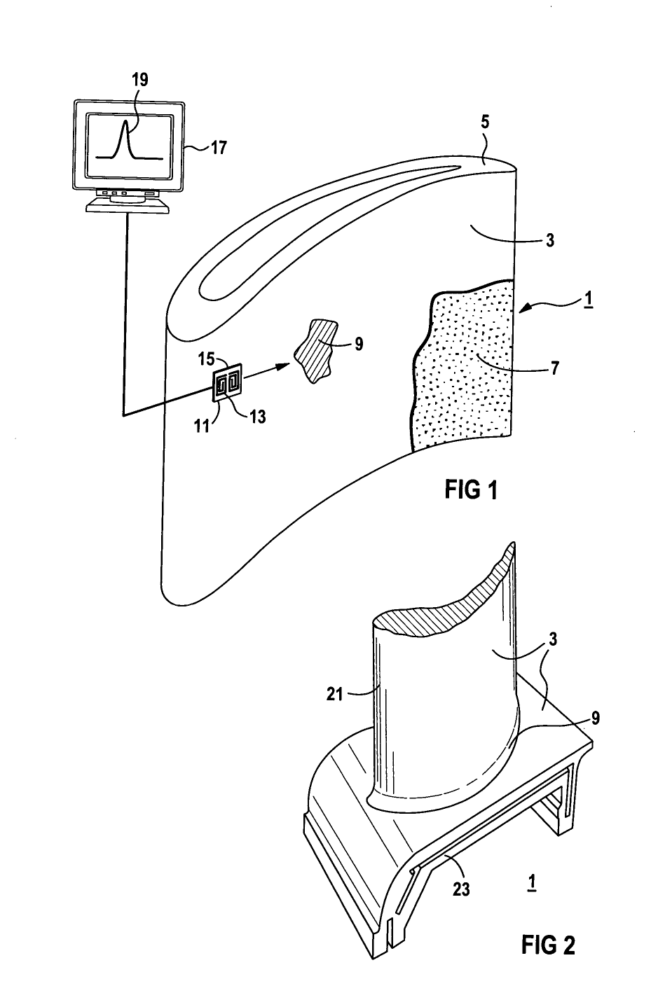

FIG. 1 A method for testing a gas turbine blade for ICO areas.

FIG. 2 A gas turbine blade with visible ICO areas.

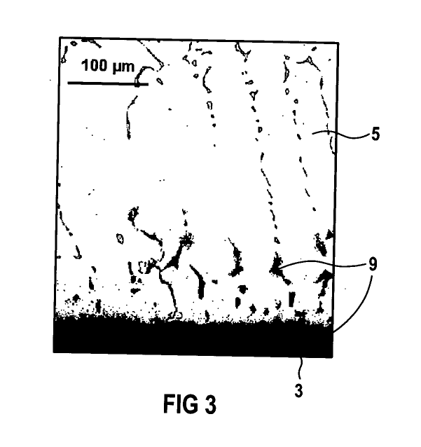

FIG. 3 Part of a lengthwise section through the main body of a gas turbine blade with an ICO coating.

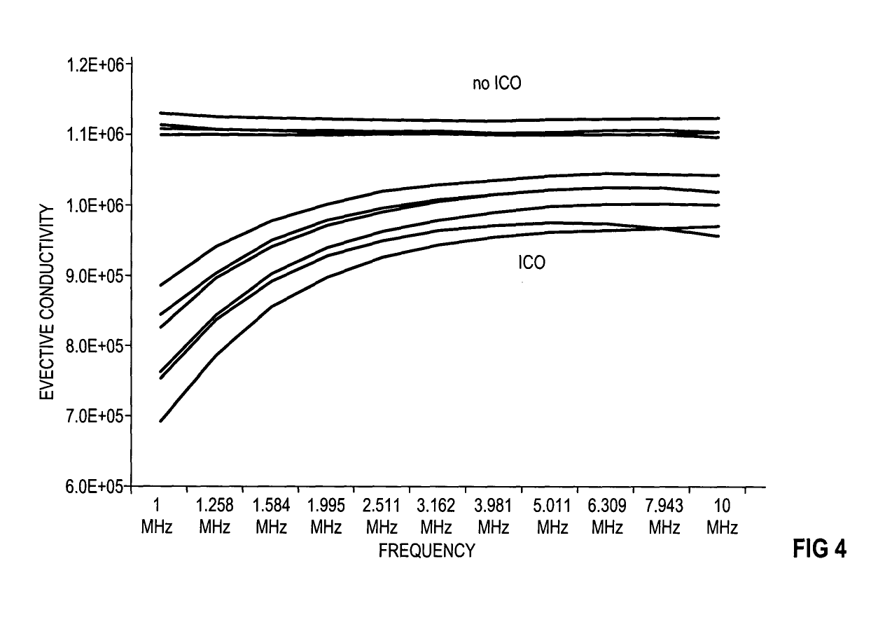

FIG. 4 A diagram showing the frequency-related effective conductivity of specimens with and without ICO areas.

Reference characters that are the same in the different illustrations have the same meaning.

FIG. 1 is a schematic showing a method for non-destructive testing of a gas turbine blade 1 using the eddy-current test method. The gas turbine blade 1 has a main body 5. The main body 5 has a surface 3. A protective coating 7 is applied to a part area of the surface 3, which for completeness was included in FIG. 1 even though the application of this protective coating 7 does not take place until after an eddy-current test has been successfully performed. A corrosion area 9, or an oxide area 9 of oxidated carbides, has occurred on the surface 3 due to a reaction with a mold (not illustrated) in the casting process when casting the gas turbine blade 1. Carbides have converted to oxides in this corrosion area or oxidated area 9 due to a reaction with oxygen from this mold. Also, a corrosion area 9 of sulfidized parent material can have arisen on the surface 3 due to high-temperature corrosion, for example in service.

On one hand this leads to a reduction in the material of the main body in this area, because the strengthening effects of the carbides on the grain boundaries is absent. Furthermore, this also means that cleaning and activation using a sputter process in the corrosion area 9 carried out before applying the protective coating 7 is ineffective. This causes the bond between the protective coating 7 and the main body 5 to be substantially impaired. In order to determine interfering corrosion areas 9 before the expensive cleaning and coating process, an eddy-current measuring method is used. To do this, an eddy-current probe 11 is passed over the surface 3. Electric coils 13, by means of which a magnetic field is generated due to an alternating current through the coils 13, are arranged on a flexible plastic carrier 15. This induces electric currents in the surface 3 that are in turn fed back via their magnetic field to the coils 13. This is visible as a signal 19 in an evaluation unit 17 connected to the eddy-current probe 11. Depending particularly on the electrical conductivity, but also on the magnetic permeability, of the material in the area of the eddy-current probe 11, a signal 19 with a varying strength results. This can be detected by the eddy-current probe 11 due to the different electrical conductivity and magnetic susceptibility in the corrosion area 9. Furthermore, a depth for the corrosion area 9 can be determined by a frequency change in the alternating field of the eddy-current probe 11. Thus it is possible for the first time to verify corrosion areas (ICO) 9 non-destructively. This has particularly substantial cost advantages because the blades can be ground clean, or rejected, before an expensive cleaning and coating process.

FIG. 2 shows ICO areas 9 of a gas turbine blade 1 visible after cleaning and activating using the sputter process. The ICO areas 9 in this case are particularly concentrated in a transition area between the turbine blade itself 21 and the blade root area 23.

FIG. 3 is a lengthwise section showing the formation of an ICO area 9 on the surface 3 of a main body 5. The main body 5 consists of the aforementioned MAR-M 509 cobalt-based superalloy. The ICO coating is approximately 100 μm thick.

FIG. 4 is a diagram showing the relationship between frequency and effective conductivity of probes with and without ICO areas.

1. Method for non-destructive testing of carbide-containing alloys, with near-surface oxide areas (9) of oxidated carbides being determined by means of eddy-current measurement.

2. Method for non-destructive testing of a gas turbine blade (1) of a carbide-containing alloy, with the near-surface oxide areas (9) of oxidated carbides being determined by means of eddy-current measurement.

3. Method in accordance with claim 2,
with the alloy being a nickel- or cobalt-based superalloy.

4. Method for the manufacture of a gas turbine blade (1), with a main body (5) of the gas turbine blade (1) being cast, the surface (3) of the main body (5) being cleaned and activated for the application of an anti-corrosive coating (7), and the anti-corrosive coating (7) then being applied, with the surface being tested for the presence of oxide areas of oxidated carbides using eddy-current measurement after the casting and before the cleaning and activating.

5. Method in accordance with claim 4,
with the main body (5) consisting of a nickel- or cobalt-based superalloy.

6. Method in accordance with claim 5,
with the protective coating (7) consisting of a MCrAlY type of alloy, with M being selected from the (Fe, Co, Ni) group, Cr chrome, Al aluminum and Y from the (Y, La, rare earths) group.

7. Method for non-destructive testing of a nickel- or cobalt-based alloy with near-surface sulfidized corrosion areas (9) being determined by means of eddy-current measurements.

8. Method of non-destructive testing of a gas turbine blade (1) of nickel- or cobalt-based alloy, with the near-surface sulfidized corrosion areas (9) being determined by means of eddy-current measurements.
